(19) United States
(12) Patent Application Publication
(10) Pub. No.: US 2008/0162827 A1
(43) Pub. Date: Jul. 3, 2008

(54) Symmetric inter-partition channel to stream data between partitions

(76) Inventor: Thomas Schultz, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/648,216

(22) Filed: Dec. 29, 2006

(51) Int. Cl. G06F 12/00

(52) U.S. Cl. 711/153; 711/E12.001

(57) ABSTRACT

In some embodiments, an inter-partition apparatus includes a set of registers to store direct memory access (DMA) controls and to store an access control list visible to two or more operating environments separated by a partition, the set of registers including posted receive buffers and transmit pending buffers. A DMA device streams data in both directions between the two or more operating environments in response to the stored DMA controls and in response to the access control list using the posted receive buffers and the transmit pending buffers. Other embodiments are described and claimed.

### RELATED APPLICATIONS

This application is related to U.S. patent application Ser. No. 11/027,253 filed on Dec. 30, 2004. This application is also related to U.S. patent application Ser. No. 11/241,247 filed on Sep. 30, 2005.

### TECHNICAL FIELD

The inventions generally relate to a symmetric inter-partition channel to stream data between partitions.

### BACKGROUND

Modern computing systems may utilize multiple sets of processing resources, including perhaps processing cores, hyper-threads, and memory. A set of processing resources may be referred to herein as a “partition.” Some ideas of dealing with partitions that have been contemplated by the inventor include asymmetric inter-partition channels (IPCs) where each side of the IPC is different, and software implementations such as using an operating system (OS) and exposing an inter-partition bridge (IPB) using advanced configuration and power interface (ACPI) tables.

An asymmetric IPC implementation would likely require a special partition to support the device implementation side of the IPC. Regarding software implementations, previous patent application Ser. No. 11/241,247 entitled “EXPOSED SEQUESTERED PARTITION APPARATUS, SYSTEMS, AND METHODS” filed on Sep. 30, 2005 discusses an advanced configuration and power interface (ACPI) software exposure aspect of an inter-partition bridge (IPB). This application deals with exposing IPBs through ACPI software, and also discusses how a pseudo device (a system that believes that a device exists, where none really exists) is used to implement the IPB.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a platform according to some embodiments of the inventions.

FIG. 2 illustrates an apparatus according to some embodiments of the inventions.

FIG. 3 illustrates a set of registers according to some embodiments of the inventions.

### DETAILED DESCRIPTION

Some embodiments of the inventions relate to a symmetric inter-partition channel to stream data between partitions.

In some embodiments, an inter-partition apparatus includes a set of registers to store direct memory access controls and to store an access control list visible to two or more operating environments separated by a partition, the set of registers including posted receive buffers and transmit pending buffers. A direct memory access device streams data in both directions between the two or more operating environments in response to the stored direct memory access controls and in response to the access control list using the posted receive buffers and the transmit pending buffers.

In some embodiments a system includes a processor and an inter-partition device. The inter-partition device streams data in both directions between two or more operating environments of the processor that are separated by a partition. The inter-partition device includes a set of registers and a direct memory access device. The set of registers stores direct memory access controls and also stores an access control list visible to the two or more operating environments, and includes posted receive buffers and transmit pending buffers. The direct memory access device streams data in both directions between the two or more operating environments in response to the stored direct memory access controls and in response to the access control list using the posted receive buffers and the transmit pending buffers.

In some embodiments inter-partition communication is implemented by storing in one or more registers direct memory access controls and an access control list visible to two or more operating environments separated by a partition. Data is streamed in both directions between the two or more operating environments in response to the stored direct memory access controls and in response to the access control list using direct memory access and using posted receive buffers and transmit pending buffers.

In some embodiments, computer platforms utilize partitioning of system resources including processor threads and/or processor cores. In some embodiments, communication is implemented in a controlled way between partitions, for example, relating to a platform resource layer (PRL) and/or many core implementations.

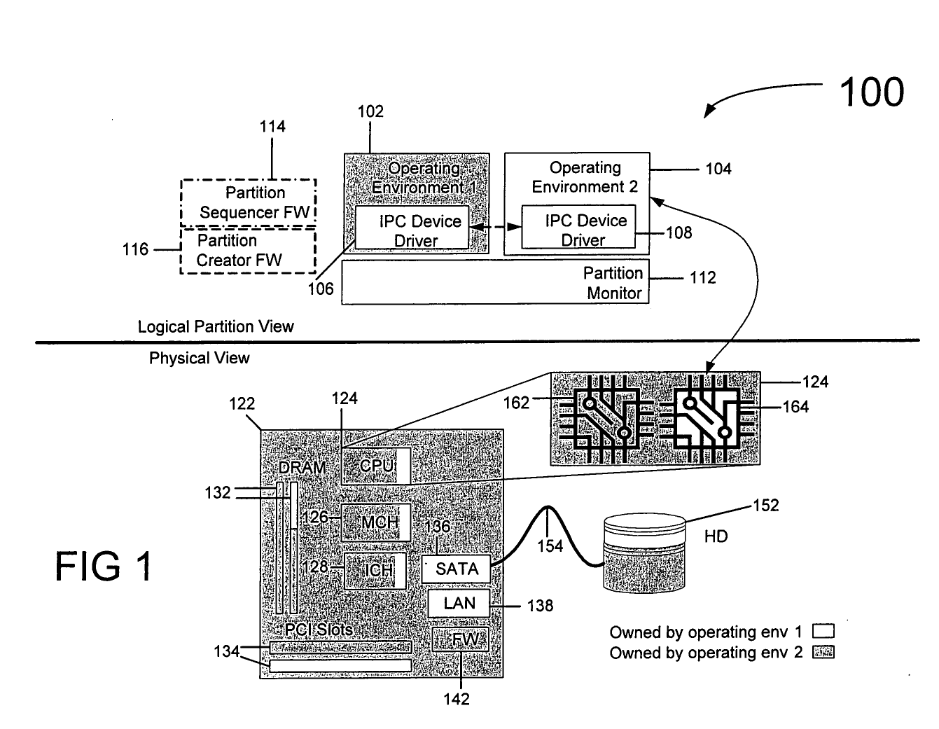

FIG. 1 illustrates a computer platform 100 according to some embodiments. FIG. 1 provides a context for a symmetric inter-partition channel (IPC). The upper portion of FIG. 1 (above the line) illustrates a logical view of partitioning with two operating environments shown (operating environment 102 and operating environment 104). Although two operating environments are illustrated in FIG. 1, it is recognized that any number of operating environments may be implemented according to some embodiments.

It is useful to partition a computer platform such as platform 100 such that one or more operating environments can run simultaneously. A useful partitioned platform typically exists if there are one or more computational cores on the platform (for example, a central processing unit or CPU in the platform includes one or more computational cores). Partitioning is accomplished by dividing up the platform resources (for example, one or more of Dynamic Random Access Memory or DRAM, peripheral devices, and/or CPU cores, etc.) and by reporting different portions of the divided resources to multiple operating environments. Each of the operating environments is centered on one or more computational cores (for example, CPU cores). In some embodiments, using hardware mechanisms, the resource division may be enforced such that one operating environment cannot damage the operation of another operating environment.

Each of the operating environments 102 and 104 illustrated in FIG. 1 includes a symmetric inter-partition channel (IPC) device driver that accesses real hardware registers. Operating environment 102 includes an IPC device driver 106 and operating environment 104 includes an IPC device driver 108. The logical partition view of platform 100 further includes a partition monitor 112, a partition sequencer 114 (for example, in some embodiments implemented in firmware), and a partition creator 116 (for example, in some embodiments implemented in firmware). In some embodiments the partition monitor 112 and the partition creator 116 are the only entities that can configure the symmetric IPC hardware.

The bottom half of FIG. 1 (below the line) illustrates a physical view of partitioned resources, for example, including a motherboard 122 including a central processing unit 124 (for example, a processor with multiple cores and/or with hyper threading technology), a memory controller hub (MCH) or northbridge 126, an Input/Output controller hub (ICH) or southbridge 128, memory such as dynamic random access memory (DRAM) 132, Peripheral Component Interconnect (PCI) slots 134, Serial Advanced Technology Attachment (SATA) circuitry 136, Local Area Network (LAN) circuitry 138, and firmware 142. SATA circuitry 136 couples the motherboard and elements thereon to a hard disk drive (and/or drives) 152 via, for example, a SATA cable 154. CPU 124 is also shown in FIG. 1 in an exploded view, for example, with two cores 162 and 164, although CPU 124 may have any number of cores.

FIG. 1 further illustrates in white resources that are owned by operating environment 2 (104) and in dark resources that are owned by operating environment 1 (102).

In some embodiments, hardware (for example, implemented in silicon) is provided that prevents operations in one operating environment (and/or core) to access memory allocated for the other operating environment (and/or core). This presents a problem when a controlled useful access is required by the other operating environment (and/or core). For example, it must be determined what happens if one operating environment (and/or processing environment and/or core) provides a service required by the other operating environment. In some embodiments, a mechanism is provided to bridge the two operating environments and provide a communication channel between the two environments. This communication channel appears as the same device to each of the two (or more) operating environments. In some embodiments, the communication channel provides a secure way (for example, point-to-point way) to stream information between partitions. In some embodiments the mechanism can be exposed as a platform device described in the ACPI (Advanced Configuration and Power Interface) tables presented to each operating environment. This mechanism appears as the same device to both operating environments. This “same device” feature can be described as a “symmetric” way to provide inter-partition channels according to some embodiments.

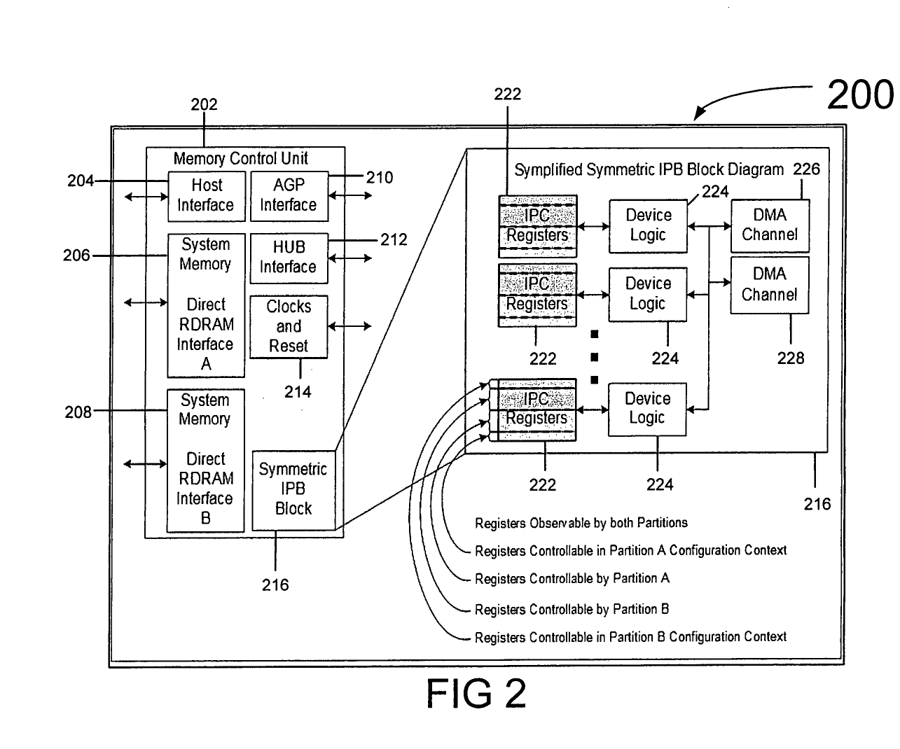

FIG. 2 illustrates an apparatus 200 according to some embodiments. In some embodiments, apparatus 200 is a memory control unit 202 and/or includes a memory control unit 202. In some embodiments memory control unit 202 may be implemented in hardware (for example, in silicon). In some embodiments memory control unit 202 may be included in a memory controller hub (MCH) such as, for example, MCH 126 illustrated in FIG. 1.

In some embodiments memory control unit 202 includes a host interface 204, a system memory direct memory interface A 206 (for example, a direct Rambus Direct Random Access Memory or direct RDRAM), a system memory direct memory interface B 208 (for example, a direct Rambus Direct Random Access Memory or direct RDRAM), an Advanced Graphics Port (AGP) interface 210, a HUB interface 212, clocks and reset circuitry 214, and a symmetric inter-partition bridge (IPB) logic block 216. In some embodiments FIG. 2 includes a high level micro architecture diagram for the symmetric IPB block 216. In some embodiments, the IPB block 216 has one or more IPCs. It is noted that an IPB is used synonymously with IPC when there is only one channel. However, the IPB may have more than one channel (and therefore more than one IPC). FIG. 2 illustrates the relationship between IPB and multiple IPCs.

IPB block 216 is shown in an exploded view in FIG. 2. In some embodiments IPB block 216 includes one or more inter-partition channel (IPC) registers 222, one or more device logic blocks 224, a direct memory access channel (DMA channel) 226, and a DMA channel 228. In some embodiments, registers in each of the register sets 222 are observable by more than one partition such as “partition A” and “partition B” (or more than one operating environment). In some embodiments as illustrated in FIG. 2, the top two sections of one or more of each of the sets of IPC registers 222 are controlled by one partition (for example, “partition B”) and the bottom two sections of one or more of each of the sets of IPC registers 222 are controlled by another partition (for example, “partition B”). In some embodiments, some of the registers of one or more of the IPC registers 222 are controllable in a “partition A” configuration context, some are controllable by “partition A”, some are controllable by “partition B”, and/or some are controllable in a “partition B” configuration context. In some embodiments, some of the registers can be modified in ring 0 format, while other registers need to be accessed in a protected configuration mode.

In some embodiments, device registers (for example, one or more IPC register sets 222 and/or one or more registers within IPC register sets 222) have status which allows both sides of the IPC (that is, two or more partitions) to synchronize a state of the data stream (for example, “device operational”, “device driver loaded”, etc.) The device implements a direct memory access (DMA) engine (for example, via DMA channel 226 and/or DMA channel 228) that allows for the streaming of data through the IPC. The DMA engine is subject to an access control list (ACL) of physical memory pages submitted by a trusted configuration entity on each side (each partition) of the IPC, for example. The trusted configuration entity on each side of the IPC sets up a table of pages (on the respective side) that are accessible on their side through the IPC. The DMA channel (for example, implemented in silicon) is part of the disclosure, and checks the tables to make sure that the DMA operation is permitted. If the DMA operation is not permitted, then DMA does not occur.

As illustrated in FIG. 2, a simplified symmetric IPB block such as IPB block 216 may contain multiple IPCs which are, for example, identical but separate. Each IPC has its own set of IPC registers 222. In some embodiments in which multiple IPCs are included in an IPB block, the operating environment application that uses the IPC is different for each of the IPCs (for example, a network on one IPC, streaming media on another IPC, etc.)

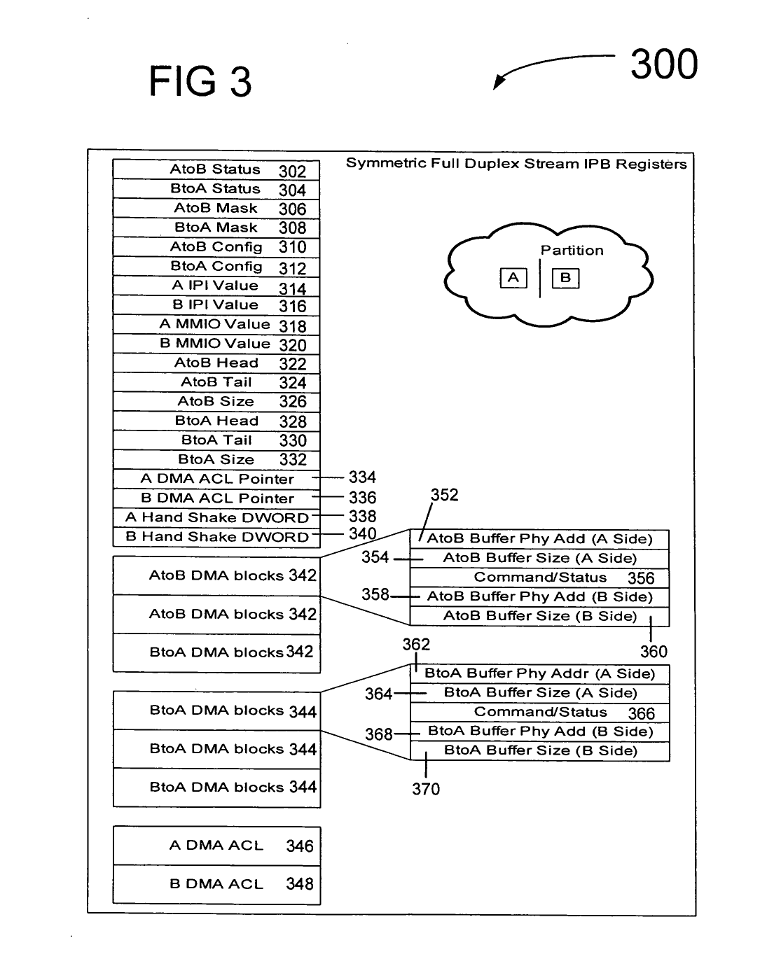

FIG. 3 illustrates a register set 300 according to some embodiments. In some embodiments, register set 300 is a register set for a single symmetric IPC (for example, one or more of the IPC register sets 222 illustrated in FIG. 2). In some embodiments, register set 300 is a symmetric full duplex stream of IPB registers. In some embodiments, register set 300 includes a “Partition A” to “Partition B” status register 302,. a “Partition B” to “Partition A” status register 304, a “Partition A” to “Partition B” mask register 306, a “Partition B” to “Partition A” mask register 308, a “Partition A” to “Partition B” configuration register 310, a “Partition B” to “Partition A” configuration register 312, a “Partition A” intelligent peripheral interface (IPI) value register 314, a “Partition B” IPI value register 316, a “Partition A” memory-mapped input/output (MMIO) value register 318, a “Partition B” MMIO value register 320, a “Partition A” to “Partition B” head register 322, a “Partition A” to “Partition B” tail register 324, a “Partition A” to “Partition B” size register 326, a “Partition B” to “Partition A” head register 328, a “Partition B” to “Partition A” tail register 330, a “Partition B” to “Partition A” size register 332, a “Partition A” DMA ACL pointer register 334, a “Partition B” DMA ACL pointer register 336, a “Partition A” hand shake DWORD (for example, double word that is 32 bits wide), register 338, a “Partition B” hand shake DWORD register 340, one or more “Partition A” to “Partition B” DMA register blocks 342, one or more “Partition B” to “Partition A” DMA register blocks 344, a “Partition A” DMA ACL register 346, and/or a “Partition B” DMA ACL register 348.

In some embodiments, one or more of the “Partition A” to “Partition B” DMA register blocks 342 include a “Partition A” to “Partition B” Buffer Physical Address (A Side) register 352, a “Partition A” to “Partition B” Buffer size (A side) register 354, a command/status register 356, a “Partition A” to “Partition B” Buffer Physical Address (B Side) register 358, and/or a “Partition A” to “Partition B” Buffer size (B side) register 360. In some embodiments, one or more of the “Partition B” to “Partition A” DMA register blocks 344 include a “Partition B” to “Partition A” Buffer Physical Address (A Side) register 362, a “Partition B” to “Partition A” Buffer size (A side) register 364, a command/status register 366, a “Partition B” to “Partition A” Buffer Physical Address (B Side) register 368, and/or a “Partition B” to “Partition A” Buffer size (B side) register 370.

In some embodiments the “Partition A” to “Partition B” DMA blocks and/or the “Partition B” to “Partition A” DMA blocks are double ringed. That is, addresses for both the transmitting side and the receiving side are visible in the same structure in the registers of the device. This makes is possible for a symmetrical and useful device. Further, the DMA access control list is accessible in the registers so that, for example, the DMA engine is able to check the ACL registers prior to DMA operations.

As discussed above, having multiple partitions is becoming very popular in the computer industry. Some embodiments provide a very natural model to stream data across partitions. In some embodiments, communication is provided across partitions in a manner such that both sides can treat the communication channel in the same way. It is not necessary to distinguish between the consumer of the data and the provider of the data, as would be in the case of using an asymmetric inter-partition channel device. Implementation in hardware (for example, in silicon) is a natural embodiment for such a symmetric IPC device.

In some embodiments, symmetric IPC solves a general partitioning inter-partition channel problem. In some embodiments, the same sample driver core code can be used on either side of the inter-partition bridge, providing a very clean and easily implemented solution. There is no requirement that the bridged partitions have specialized roles in view of the symmetric nature of the IPC.

In some embodiments, two or more partitions see the same device from different sides. In some embodiments, a double ring is used (posted receive buffers and transmit pending buffers). The double ring is located in the registers, allowing for out of order return of receive buffers, and performs streaming such that silicon and software driver code may be reused. This results in a symmetric nature for an IPC, since the same software driver core can be used from both sides.

In some embodiments, IPC devices are implemented in a memory controller block (for example, that is physically close to the CPU and can make the device perform in a fast manner). In some embodiments, device discovery does not involve, for example, PCI enumeration which adds complexity to the silicon design. Instead, in some embodiments, ACPI may be used for device discovery.

In some embodiments, the streaming model looks like a mail box when the number of buffers is reduced to one. In this manner, the design decomposes to a mailbox model when the number of buffers are limited, providing the driver writer with flexibility in the way that the device functions.

IN some embodiments, an IPB device and/or an IPC device are implemented in silicon, and page table entries where DMA can be performed on that data are also in registers accessed only by a trusted entity. If the page lists are empty, the silicon does not perform DMA. This results in a secure and fast device.

Some embodiments apply to a partitioned computer platform having more than one CPU core and/or hardware thread, where data is shared through a partition boundary.

In some embodiments, symmetric IPC devices are exposed to the operating system (OS) so that device drivers can be loaded. In some embodiments, a stream of data may be produced in one partition and consumed in another partition.

In some embodiments, a symmetric IPC device (and/or symmetric IPB device) are implemented in silicon and exposed in registers that are included in a chip set (for example, in a memory controller hub of a chipset).

In some embodiments, a symmetric IPC device such as IPB device 216 in FIG. 2 is an inter-partition channel that is completely implemented in silicon. In some embodiments an array of symmetric IPC devices are implemented at the memory complex in a computer system. In some embodiments the IPC device is a point-to-point device that both operating environments on either side of a partition have access to (and/or that two or more operating environments or partitions have access to).

In some embodiments, an IPC device is a minimalist robust DMA streaming interface. In some embodiments, the streaming interface involves two or more DMA channels (for example, for full duplex streams). In some embodiments, the two or more streams are implemented using a double ring of memory pointers for each direction. The use of a double ring (that is, for example, posted receive buffers and transmit pending buffers) located in the registers allows for out of order return of receive buffers, and provides all properties of a great streaming device. Since this mechanism is the same in each direction, it is possible to reuse the silicon and drivers for each direction, providing the symmetric nature of the IPC. Further, the same software driver core can be used from both sides.

In some embodiments, the DMA engine (for example, DMA hardware engine) checks an access control list (ACL) included within the IPC registers prior to DMA operations. A page list is write accessible in configuration context, and is implemented in ACL registers. In some embodiments only a small number of ACL registers is necessary. In some embodiments, each operating environment builds the access control list (ACL) and registers the list to the IPB device. Otherwise, the DMA engine does not perform any DMA operations through the IPC.

In some embodiments, the configuration of the IPC is done in a privileged mode on both sides of the IPC (that is, in two or more operating environments or partitions). In some embodiments, two or more partitions see the same device from different sides.

In some embodiments an array of symmetric IPCs are implemented at a memory complex. In some embodiments, an IPC hardware device is implemented in silicon for each IPC. In some embodiments, the IPC device is identified to two or more operating environments using ACPI tables. In some embodiments, synchronization between two or more sides of an IPC is maintained through status bits available in registers visible to two or more operating environments.

In some embodiments, a hardware inter-partition channel (IPC) has a performance advantage over virtualization techniques used to perform similar functions. In some embodiments, a hardware IPC is used by virtualization technology to perform inter-partition bridging and channeling functions.

In some embodiments, a symmetric inter-partition channel (IPC) is used for general partitioning in a system where two or more operating environments operate on two or more sides of an inter-partition channel (IPC). In some embodiments, two or more operating environments load a driver for an inter-partition channel in a manner that is natural for the two or more operating environments, with no driver loading temporal order, for example.

In some embodiments IPC and DMA operations are implemented in silicon, and the DMA operations are subject to an access control list (ACL) and the configuration of an IPC is performed only in a privileged mode, thus providing a secured IPC.

In some embodiments, core driver code requires interfacing an IPC device in a manner that is common for all drivers, and the core driver code can be given out as a driver reference. Giving out the driver code does not compromise security because security is derived from the access control list, which is populated by the privileged partition manager, for example.

In some embodiments, data copies are performed using DMA channels rather than by using CPU cores.

The terms “inter-partition bridge” (or “IPB”) and “inter-partition channel” (or “IPC”) are used herein in very similar ways. It is noted that in cases where an IPB has only one IPC, these terms are interchangeable with each other, and have the same meaning. However, an IPB can have one or more IPC channel. For example, in some embodiments (for example, as illustrated in FIG. 2) an IPB block has multiple IPC sets of registers. Each IPC set of registers corresponds to a single IPC. FIG. 2 illustrates three sets of IPC registers 222, but that number of sets of IPC registers is arbitrary and in some embodiments the number of IPCs (and associated sets of registers 222) can be any number of one or more.

Although some-embodiments have been described herein as being implemented in hardware and/or in silicon, according to some embodiments these particular implementations may not be required.

Although some embodiments have been described herein as two or more operating environments that correspond to two or more different cores in a single processor package and/or that operate on two or more hardware threads in a single processor core, in some embodiments, the two or more different cores and/or the two or more hardware threads may not be contained in a single processor package. They may be contained in two or more different processor packages, for example. In some embodiments each of the different cores and/or hardware threads may be contained in a processor package that is different than all the other different cores and/or hardware threads, for example, or in some embodiments, for example, some of the different cores and/or different hardware threads are contained in a first processor package and others of the different cores and/or different hardware threads are contained in a second processor package.

In some embodiments, the IPC is implemented within an MCH. In some embodiments, more than one processor may be coupled with the same MCH, and more than one processor package containing multiple cores can use the same IPC, for example.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An inter-partition apparatus comprising:
a set of registers to store direct memory access (DMA) controls and an access control list visible to two or more operating environments separated by a partition, the set of registers including posted receive buffers and transmit pending buffers; and
a DMA device to stream data in both directions between the two or more operating environments in response to the stored DMA controls and in response to the stored access control list using the posted receive buffers and the transmit pending buffers.

2. The inter-partition apparatus of claim 1, wherein the inter-partition apparatus is included in a memory controller hub.

3. The inter-partition apparatus of claim 1, wherein the access control list is a list of physical memory pages submitted by a trusted configuration entity in each of the two or more operating environments.

4. The inter-partition apparatus of claim 1, wherein the two or more operating environments each correspond to a different core contained in a single processor package.

5. The inter-partition apparatus of claim 1, wherein the two or more operating environments each correspond to a different core, the different cores contained in at least two different processor packages.

6. The inter-partition apparatus of claim 1, wherein the two or more operating environments each operate on a different hardware thread contained in a single processor package.

7. The inter-partition apparatus of claim 1, wherein the two or more operating environments each operate on a different hardware thread, the different hardware threads contained in at least two different processor packages.

8. The inter-partition apparatus of claim 1, wherein some registers in the set of registers are controllable by only a first of the operating environments and other registers in the set of registers are controllable by only a second of the operating environments, and all registers in the set of registers are observable by the first operating environment and by the second operating environment.

9. The inter-partition apparatus of claim 1, wherein the inter-partition apparatus is implemented in silicon.

10. A system comprising:
a processor; and
an inter-partition device to stream data in both directions between two or more operating environments of the processor that are separated by a partition, the inter-partition device including:
a set of registers to store direct memory access (DMA) controls and to store an access control list visible to the two or more operating environments, the set of registers including posted receive buffers and transmit pending buffers; and
a DMA device to stream data in both directions between the two or more operating environments in response to the stored DMA controls and in response to the stored access control list using the posted receive buffers and the transmit pending buffers.

11. The inter-partition system of claim 10, wherein the inter-partition apparatus is included in a memory controller hub.

12. The inter-partition system of claim 10, wherein the access control list is a list of physical memory pages submitted by a trusted configuration entity in each of the two or more operating environments.

13. The inter-partition system of claim 10, wherein the two or more operating environments each correspond to a different core of a single processor package.

14. The inter-partition system of claim 10, wherein the two or more operating environments each correspond to a different core, the different cores contained in at least two different processor packages.

15. The inter-partition system of claim 10, wherein the two or more operating environments each operate on a different hardware thread contained in a single processor package.

16. The inter-partition system of claim 10, wherein the two or more operating environments each operate on a different hardware thread, the different hardware threads contained in at least two different processor packages.

17. The inter-partition system of claim 10, wherein some registers in the set of registers are controllable by only a first of the operating environments and other registers in the set of registers are controllable by only a second of the operating environments, and all registers in the set of registers are observable by the first operating environment and by the second operating environment.

18. The inter-partition system of claim 10, wherein the inter-partition apparatus is implemented in silicon.

19. A method of inter-partition communication comprising:
storing in one or more registers direct memory access (DMA) controls and an access control list visible to two or more operating environments separated by a partition;
streaming data in both directions between the two or more operating environments in response to the stored DMA controls and in response to the stored access control list using direct memory access and using posted receive buffers and transmit pending buffers.

20. The method of claim 19, wherein the access control list is a list of physical memory pages submitted by a trusted configuration entity in each of the two or more operating environments.

21. The method of claim 19, wherein the two or more operating environments each correspond to a different core contained in a single processor package.

22. The method of claim 19, wherein the two or more operating environments each correspond to a different core, the different cores contained in at least two different processor packages.

23. The method of claim 19, wherein the two or more operating environments each operate on different hardware threads contained in a single processor package.

24. The method of claim 19, wherein the two or more operating environments each operate on a different hardware thread, the different hardware threads contained in at least two different processor packages.
